(19) United States
(12) Patent Application Publication
(10) Pub. No.: US 2013/0124281 A1
(43) Pub. Date: May 16, 2013

(54) SYSTEM AND METHOD FOR CUSTOMER INCENTIVE DEVELOPMENT AND DISTRIBUTION

(71) Applicants: Perry R. Evans, Littleton, CO (US); Thomas B. Bender, Boulder, CO (US)

(72) Inventors: Perry R. Evans, Littleton, CO (US); Thomas B. Bender, Boulder, CO (US)

(73) Assignee: CLOSELY, INC., Denver, CO (US)

(21) Appl. No.: 13/470,017

(22) Filed: May 11, 2012

Related U.S. Application Data
(60) Provisional application No. 61/485,784, filed on May 13, 2011.

(51) Int. Cl. G06Q 30/02

(52) U.S. Cl. CPC G06Q 30/0213
USPC 705/14.13

(57) ABSTRACT

A system for advertising and promotion comprises identifying a promotion to be offered to a consumer, identifying a consumer that is interested in the promotion, identifying a plurality of consumer-specific attributes, using at least one of the consumer-specific attributes to determine a promotion offering value, offering the promotion to the consumer at the promotion offering value determining whether the consumer agrees to purchase the promotion at the promotional offering value, and determining whether to adjust the promotional offering value based on whether the consumer agreed to purchase the promotion.

### PRIORITY AND RELATED APPLICATIONS

This application claims priority to U.S. Provisional Patent Application No. 61/485,784 filed on May 13, 2011. The details of Application No. 61/485,784 are incorporated into the present application by reference in their entirety and for all proper purposes.

### FIELD OF THE INVENTION

Aspects of the present invention relate to systems and methods for the development and use of a commerce-centered social network where a business, or a proxy thereof, identifies and selects customers, offers them a digital key to unlock a live and unique time-limited promotion to pre-purchase or otherwise commit to a transaction, and then optionally identifies, selects and refers friends to act on the same or closely related promotion.

### BACKGROUND

Known promotional and “deal-of-the-day” advertising systems, such as Groupon, LivingSocial, and Saveology operate on a similar business model. Most commonly these sites operate on an assurance contract styled promotional offer that relies on volume-based registrations in order to give retailers comfort that the quantity discounts that develop will increase revenue. Risk to the retailed in giving such discounts is thus minimized. Promotional offers are generally available broadly to users of the systems, and no effort is made to distinguish or otherwise directly market the promotions. Sites collect personal information from consumers willing to sign up and contacts those consumers by email to determine whether they are interested in a particular product or service. These are purely volume driven transactions. As a result, many deals through these known systems only attract one-time bargain hunters who do not return, or further participate in the system until they encounter another promotion that suits them.

In addition, there is no incentive system, outside an individual's affection for a particular product or service, that would motivate a user to participate outside of their own personal interests or otherwise encourage participation in a promotional campaign beyond the individual.

### SUMMARY OF THE INVENTION

In accordance with one aspect, a system for advertising and promotion runs on a client-server computer platform and executes a method comprising identifying a promotion to be offered to a consumer, identifying a consumer that is interested in the promotion, identifying a plurality of consumer-specific attributes, using at least one of the consumer-specific attributes to determine a promotion offering value, offering the promotion to the consumer at the promotion offering value, determining whether the consumer agrees to purchase the promotion at the promotional offering value, and determining whether to adjust the promotional offering value based on whether the consumer agreed to purchase the promotion.

In accordance with another aspect, the system includes a merchant and consumer interface that may comprise live offer management interface, a live offer notify/select interface, a live offer social rewards interface, and a user profile interface.

Other aspects will become apparent to one of skill in the art in connection with the drawings and detailed description below.

### BRIEF DESCRIPTION OF THE DRAWINGS

Various objects and advantages and a more complete understanding of the present invention are apparent and more readily appreciated by referring to the following detailed description and to the appended claims when taken in conjunction with the accompanying drawings:

FIG. 1 illustrates one embodiment of a variable value promotion system constructed with aspects of the present invention;

FIG. 2 illustrates a data flow diagram in accordance with one embodiment of a variable value promotion system constructed with aspects of the present invention;

FIG. 3 illustrates a live promotion state diagram in accordance with one embodiment of a variable value promotion system constructed with aspects of the present invention;

FIG. 4 illustrates an opt-in state notification diagram in accordance with one embodiment of a variable value promotion system constructed with aspects of the present invention;

FIG. 5 illustrates a data flow illustrating one aspect of the variable value promotion calculation in accordance with one embodiment of the present invention;

FIG. 6 illustrates how a system constructed in accordance with aspects of the present invention may be utilized in a computer, system, machine, or other physical embodiment; and

FIGS. 7-9 show embodiments of various user and merchant interfaces that may be used in connection with aspects of the present invention.

### DETAILED DESCRIPTION

In accordance with various aspects of the invention, a promotional system generally provides a business with the foundation for a commerce-centered social network model with associated derived rankings for “best customer” and “most influential customer.” Information generated by the system may include real-time social actions enacted by businesses and customers and the related geographical, temporal and social context that the customer is operating within. In addition, such systems and methods provide continual live real-time aggregation of the selections, activities, actions and connection methods into a proprietary intelligent social scoring system that assigns values to the customer's commerce-related attributes. This allows businesses to directly and indirectly rank customers across custom segments of the information collected including business, category, location, time, social statistics and web statistics. General aspects of a system and method constructed in accordance with the present invention are described below, followed by detailed information in conjunction with reference to the included figures.

One aspect of a system and method constructed in accordance with the present invention allows a business to dynamically match customer value with incentives and reward levels across multiple businesses and markets. Return on the commercial exchange is thereby optimized. Such systems and methods may broadly include one or more of the following features or functions.

### Creation of a Private “Social Select” Promotion

In accordance with one aspect, a business interacts with a Social Select system (sometimes referred to herein as the “System”) to create an intelligent real-time promotion. The promotion may include a digital key to trigger programmatically encapsulated behavior, including the creation of a live and unique time-limited promotion to pre-purchase or otherwise commit to a commerce transaction. All spatial and temporal attributes of the Social Select promotion (sometimes referred to herein as the “Promotion”) including latitude, longitude, elevation, start date, end date and expiration date, are relative, and are set at the time the promotion is unlocked or the state is otherwise transitioned by the actions of the Social Select customer (sometimes referred to herein as the “Customer”).

The promotion creation life cycle may also include the ability for the digital key to be earned over time through System interaction, including social interaction with 3rd party networks (e.g. Twitter Share, Facebook Share, creation of Facebook Ad or a Sponsored Tweet, etc.), and by writing ratings, reviews or otherwise providing additional user generated content that provides additional context for a live Promotion.

The programmatically encapsulated behavior may include the creation of a track-able direct marketing instrument that ultimately leads to a commerce transaction, inherently allowing the system to correlate the instrument with a commerce transaction.

### Selecting a Customer to Receive a Private Promotion

Selecting a customer to receive a promotion may be executed in a variety of ways, including, but not limited to, hand selection (e.g. individually identified) by the business. This hand selection may take the form of a digital message delivered over a network or in a printed form with the required promotion details including directions for unlocking, transacting and redeeming the Promotion.

Other methods of promotion selection may include message selected customers where their selection is based on their System interaction and/or overall system score. Messaging includes any of email, 3rd Party social networks (e.g. Facebook, Twitter, etc.), phone (mobile and land line), and any other known or equivalent communication medium.

### Unlock, Purchase and Redeem Promotion

Once selected, the customer may choose to unlock or otherwise transition the promotion and optionally buy or commit to a transaction to satisfy the promotion. The actions of unlocking, purchasing, and redeeming the promotion are all scored in the context of the overall social commerce experience and continually tallied as part of the system score.

Other methods of ‘unlocking’ or ‘transitioning’ a promotion are described above and may also be based on a customer's score in the system, whereby the promotion is ‘unlocked’ on first view for some, but not others.

Other methods to ‘redeem’ a Promotion include promotions redeemed in a retail store by presenting a certificate code; promotions redeemed online at a web site by entering a certificate code; and promotions redeemed with a mobile device using any wireless network

### Sharing the Promotion

At any time in the promotion life cycle, it may be uniquely shared within the system's commerce network, as well as on 3^{rd} party public or private social networks. Sharing and the system's knowledge of sharing for scoring and rewards in corporate social connections establishes insights and inferred knowledge from multiple channels.

Promotions may be shared widely or selectively depending on desired goals, preference, and social commerce recommendation. Aspect of the System may include solicitation for reviewed content and may also include aggregation of content to improve the social commerce experience and reward.

### Scoring and Rewarding Social Action

All social actions within the system are scored and serve as input to the score and rewards system. This information is used in aggregate to support statistical modeling and recommendations for customer selection and promotion design.

Scoring and rewards are calculated based both on the social action within the network as well as the context of the social action, including one or more the following aspects:
Social influence or clout;
Category for the promotion and business;
Location of the business and customer;
Date and times associated with the Social Select life cycle;
Externally available social data for customer and business; and
Internally aggregated statistical data for customer and business.

Social select scoring and rewards are based on a dynamic and iterative model measuring both explicit and implicit value for select social actions. While the explicit values are consistent across customers, the implicitly derived value is based on deeper social context. A simple scoring scenario showing only explicit value may be comprised as follows: A user that views a promotion scores (x) points, where as a user that views and buys a promotion scores (x+y) points and a user that views, buys and shares and promotion scores (x+y+z) points. In addition, the business that created the promotion scores points and the promotion itself scores points. All of this information is processed and used internally to improve on the recommendation and reward algorithms.

### Variable Value Promotions

A variable value promotion (“VVP”) is a live instrument with a varying value based on external factors. For example, the redemption value for a live promotion instrument may vary depending on one or more of the following:
Social Score;
How any times this Promotion has been shared;
How many times this Customer has shared Promotions;
Statistical sharing trends (e.g. moving average of shares>X);
Inferred views or depth of share. Sharing with a user that has 10,000 followers, friends or otherwise connections is more valuable than a share with someone with few followers, friends or connections;
How many views based on initial share (and re-shares by network);
How many purchases based on initial share (and re-shares by network);
Any web traceable customer or business action in the System or 3rd party social network that creates additional and measurable activity surrounding a Promotion.
Time
Time of Day (e.g. Happy Hour, Early Bird Special, Increased value when demand is low and decreased value when demand is high—demand based pricing)
Day of Week (e.g. Demand based value—restaurants are slow on Monday thru Wednesday and busier Thursday thru Saturday)
Month of Year (e.g. Seasonal variation in value)
Context
Any System activity or contextual information for a customer or business user, not included in the System Score, that provides additional context surrounding a Promotion that could be used to affect the Promotion value. (e.g. user statistics, demographics, psychographics, etc.)

### Message Reward to Customer

As a consumer interacts with the Social Select system, their selections, activities and connections are scored within the context of the commerce social network. As this score affects their ranking, status or rewards, it may be actively communicated to the user using opt-in customer preferences. For example, a business may increase directly or indirectly the value of an active Social Select Promotion to increase demand, thereby triggering the system to alert the customer of the additional reward. The unique capability of a messaging system to alert customers based on dynamically changing promotion state provides a foundation for an intelligent social shopping feed.

### Social Select Mobile Remote Control

The Social Select Remote Control (“RC”) or other dashboard provides a mobile front-end to view and modify attributes directly and indirectly of a Promotion or relating to a Promotion as well as viewing related social commerce activity, including selections, actions, activities, connections and messages from external social networks. These attributes include modifying or updating any element of a Promotion including price, value, start date, end date, expiration date, sharing, location, reward, incentive, points, ratings and reviews.

### Dynamically Adjusting and Optimizing the Price of a Promotion

Included in the intelligence of the Promotion is a dynamic real-time expert pricing service that optimizes the price of the Promotion based on desired outcome and information available within the commerce social network. Using a proprietary algorithm, the System derives the best price based on customer value across businesses and markets. Using information derived from aggregated statistical models of selections, actions, activities and connections as well as personal preference models and statistics, the expert pricing service provides quantitatively scored recommendations on optimal pricing of Promotions.

### Customer Rating, Reviews and Scoring

Inverting the normal way in which ratings are applied, the System provides methods for a business to rate, review and score consumers. This information provides a socially aware, commerce-centric classification of consumers. The System continually processes ratings, reviews and social actions surrounding System interactions and transactions providing a foundation for scoring customers. Customers' ratings and reviews provide input to an overall scoring algorithm allowing customers to be ranked and compared and allows the business to factor this information into their decision making process when using the System.

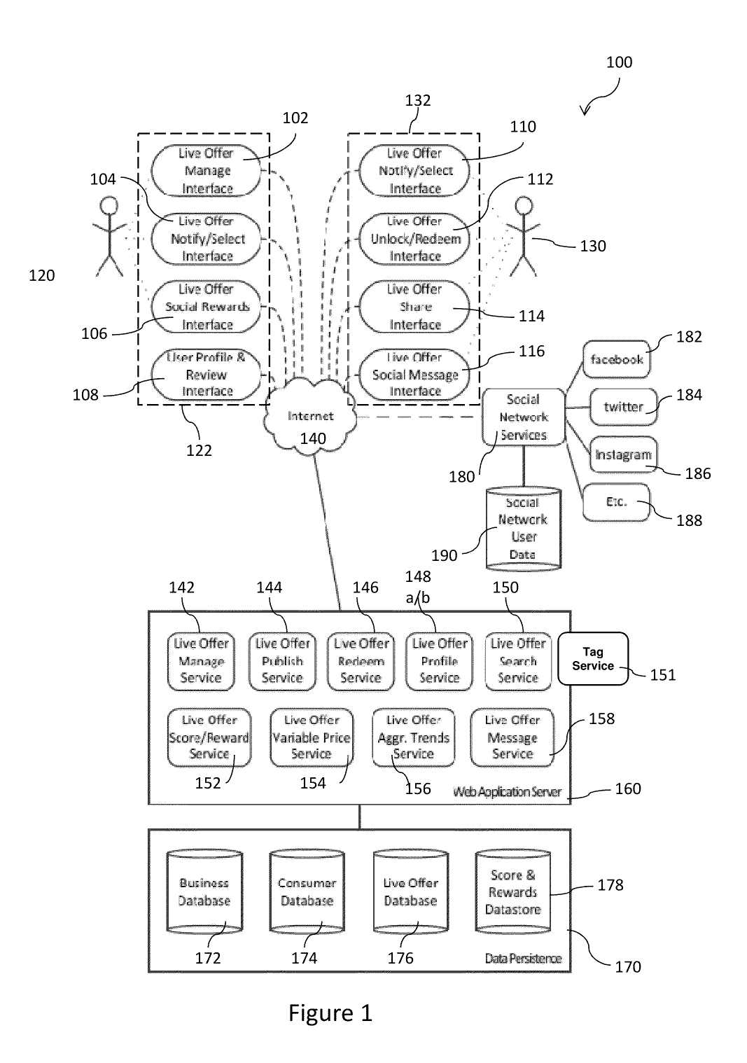

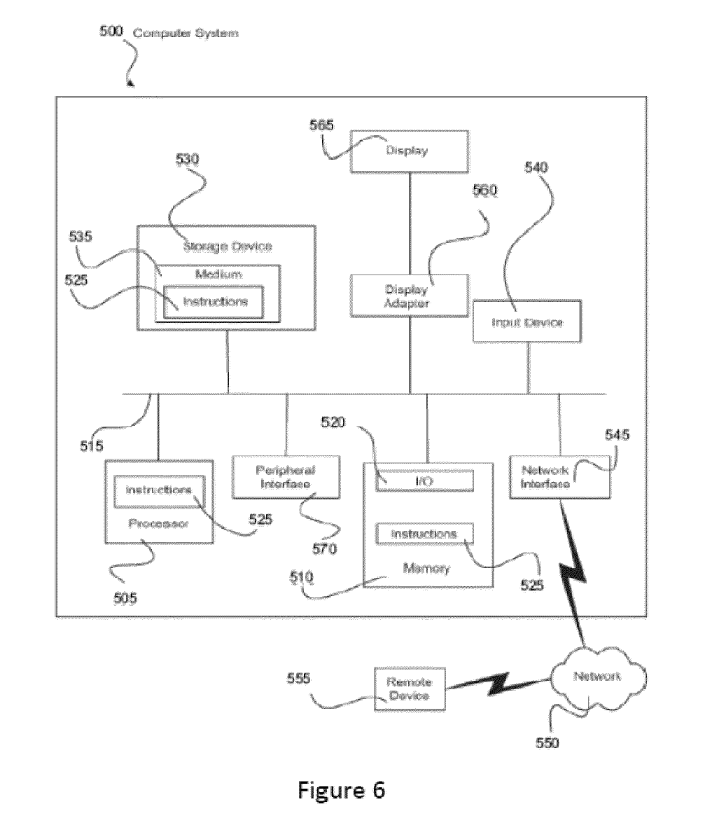

With specific reference now to the drawing Figures, FIG. 1 is a system overview of a promotional system 100 constructed in accordance with aspects of the present invention and an embodiment of how such a system may be implemented in a computer, system and/or cloud-based structure. In general, various computer servers are located at one or more locations and are adapted or otherwise programmed to perform various processes in accordance with aspects of the present invention. FIG. 6, described in more detail below, illustrates more specific hardware structure that may be used in connection with aspects of the present invention.

With continuing attention to FIG. 1, promotional system 100 serves as an advertising and promotional system and interface between a business owner or other user 120 and a consumer 130 and allows the business owner 120 to craft customized promotional offers for one or more users 130. Business user interface 122, which may comprise one or more computers, servers or other functional modules, include a live offer manager module 102, a live offer notify/select module 104, a live offer social rewards modules 106, and a user profile and review module 108.

On the user side, a user interface 132, which may also comprise one or more computers, servers or other functional modules, includes a live offer notify/select module 110, a live offer unlock/redeem module 112, a live offer share module 114, and a live offer social message module 116.

Promotional system 100 generally allows the business user 120 via manager module 102 to provide promotional services to consumer user 130. As represented in FIG. 1, the system may be embodied in a cloud based system where an application server 160 and data persistence server 170 are hosted in a remote location from the business user and are connected through the internet 140 or some other form of wide area network.

Regardless of where they are located, the application server 160 and data persistence server 170 include one or more of the following elements. Application server includes modules or other function elements used in connection with the offering of a promotion such as a manage service 142, a publish service 144, a redeem service 146, a profile service 148, a search service 150, a score/reward service 152, a variable price service 154, a aggregation trend service 156, and a message service 158. Data persistence server 170 includes one or more of a business database 172, a consumer database 174, a live offer database 176 and a score and rewards database 178.

One or more social network services 180, such as facebook 182, twitter 184, Instagram 186 and other known or equivalent social network or other customer facing services 188, feed data into the promotional system and can be utilized to further expand the system promotion as described below. A social network database 190 is in communication with the services.

Manage service 142 is responsible for orchestrating the overall customer incentive workflow from publishing 144 through redemption 146, providing a closed loop system to refine the system's ability to target and deliver the optimally priced promotion. Each of the managed services contributes to this workflow process and their specific areas of responsibility are described below

Publish service 144 is responsible for publishing a variable value promotion into select distribution channels, including coordination with the message service 158 for reliable delivery of this message.

Profile service 148 is responsible for managing access to create, find, view, update and delete profiles for both merchants and consumers. Profile service 148 includes aspects and attributes for a merchant profile 148a and a consumer profile 148b, each of which are more fully described below.

Merchant profile 148a may include one or more of the merchant name, location(s), contact information (e.g. phone, Email, website), category, hours of operation (“HOOP”), parking, handicap access, accounting information (such as POS Information), promotion information (e.g. active, queue, historical, etc.)

Consumer profile 148b may include one or more of the consumer name, location (e.g. home, work, seasonal, business travel, etc.), contact (e.g. email, phone), categories, and rating. Rating may include scoring primitives such as category score, temporal score, spend score (e.g. POS history, previous ability to influence consumer using a VVP instrument)

Search service 150 is responsible for accepting search criteria that allows the service to filter and return a subset of matching entities contained from within the larger set. These entities include consumers, merchants and promotions. Specifically, the search service allows merchants to find consumers that match a merchant opportunity profile, delivering a list of candidate VVPs along with their calculated value.

Tag Service 151 is responsible for managing the life cycle of standard and custom keywords and their association with consumer profiles, merchant profiles or promotions. These tags may be used in the fair value calculation for a VVP and provide an external input mechanism allowing a merchant to influence the algorithms to (i) assign a value to a VVP and (ii) find consumers matching a merchant opportunity.

Score/reward service 152 is responsible for quantifying and scoring a consumer relative to a merchant opportunity and optionally using this score to define a reward (e.g. custom price, delivery of a custom promotion) associated with a VVP.

Variable price service 154 is responsible for calculating and assigning value to a VVP given one or more defined merchant opportunities.

Aggregation trend service 156 is responsible for identifying, tracking and producing aggregated and statistical trend information influencing the search service 150, score/reward service 152 and the variable price service 154. These include: (i) indexing, ranking and search algorithms; (ii) suggestion and recommendation algorithms; (iii) clustering and grouping algorithms; and (iv) classification and classifier algorithms.

Redemption service 146 is responsible for creating and recording all information related to a consumer redeeming a promotion with a merchant, including all related point of sales (POS) information related to the transaction. Additionally, the service may be used to find, filter and view redemption information given customizable search criteria.

Message service 158 is responsible for reliable delivery of messages to application actors and system endpoints (e.g. consumers, merchants, promotion distribution channels) in across the system.

Data persistence server 170 is responsible for providing reliable storage and retrieval of relational and non-relational information to/from a data store.

Business database 172 contains all information related to a merchant, including profile information, associated transaction information and meta data.

Consumer database 174 contains all information related to a consumer, including profile information, associated transaction information and any meta data.

Live offer database 176 contains all information related to promotions, including all life cycle information and associated meta data.

Score and rewards database 178 contains all information, source and aggregated, required to support the score and reward service.

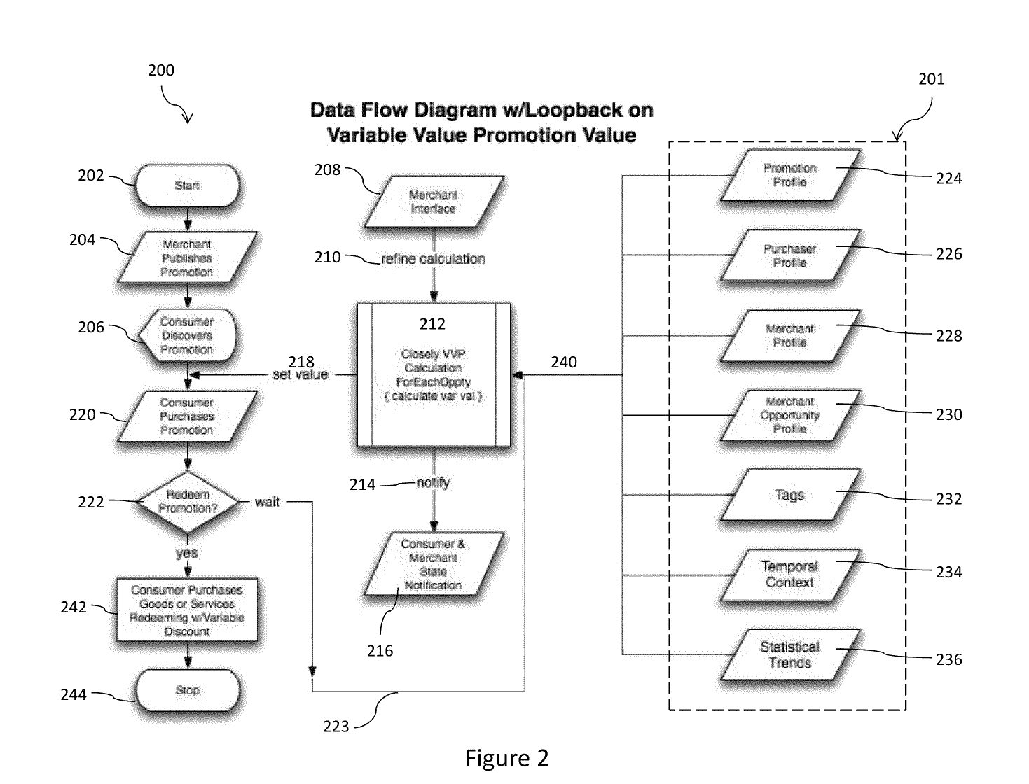

FIG. 2 depicts a process flow 200 that may be utilized in connection with aspects of the present invention. In the process 200, a merchant interface is utilized to initiate a particular promotional offering and begin the process of soliciting certain customer user. Beginning at 202 the promotional offering is initiated and a merchant publishes the particular promotional at 204. Through one of various mechanisms, a consumer is alerted or otherwise discovers the promotion at 206 and based on one or more factors, purchases the promotion at 220. Referring back to the merchant interface process beginning at 208, many different attributes are utilized to affect the value that any particular promotion may be assigned and it is this value (referred to sometimes as a variable value calculation) that is calculated at step 212 based on attribute inputs 201 (described in more detail below). The process allows for the variable value calculation engine 212 to be modified or otherwise altered and adjusted at 210 by the merchant or some other administrator of the system. The compilation of attributes that affect the variable value calculation are passed to the calculation engine at 240. One the value is set a notify function 214 notifies the merchant at 216.

Once the promotional value is calculated by engine 212 it is set at 218 and passed to the consumer interface. At 220 the consumer is presented with the promotional offer and is given an opportunity to purchase the promotion offered by the merchant at 222. If the consumer elects to purchase the promotion at 242 the process ends at 244. If the user declines to purchase the presented promotion or otherwise waits and takes no action, a feedback loop 223 reprocesses the promotion back into the variable value calculation engine 240.

### Attribute Inputs

A collection of attribute inputs 201 provides input data to the variable value calculation engine 212 in order to determine a pricing and valuation scheme for the particular promotional offering. Each of those specific values and attributes that are passed to the variable value calculation engine are described below.

A promotion profile instrument 224 captures and formats one or more of the following pieces of information pertaining to the particular promotion:

1. Promotion price—the original price paid for the live promotion instrument

2. Promotion value—the original promotional value for the live promotion instrument.

3. Value discount—original percentage discount calculated as price/value

4. Bonus Value—the bonus promotional value for the live promotion instrument

5. Bonus Value Discount—the bonus percentage discount calculated as price/bonus value

6. Date Purchased—the date and time the live promotion instrument was purchased

7. Campaign Start/End—the date and time the promotion campaign start and ended

8. Expiration Date—the date and time the live promotion instrument promotional value expires

A purchaser profile instrument 226 captures and formats one or more of the following pieces of information pertaining to the particular promotion:

1. Purchaser Identification Number: unique purchaser identifier

2. Email Address: email address of the purchaser

3. Home Location: Home address of the purchaser

4. Work Location: Work address of the purchaser

5. Social Context/Sharing Statistics: Data pertaining to the purchasers social network metrics

6. Number of times this promotion has been shared

7. How many views based on this user's sharing (and re-shares by network)

8. How many purchases based on initial share by user (and re-shares by network)

9. Statistical sharing trends (e.g. moving average of shares>X)

10. Inferred views or depth of share. (e.g. sharing with a user that has more than a certain threshold number of followers, friends or otherwise connections is more valuable than a share with someone with few followers, friends or connections)

A merchant profile instrument 228 and a merchant opportunity profile instrument 230 capture and format one or more of the following pieces of information pertaining to the particular promotion: The profile comprises a set of one or more merchant defined goals and a corresponding budget allocation, monetary or otherwise, to influence desired behavior (e.g. more high rated customers between 11 am-3 pm Mon, Tues & Wed). A merchant opportunity is comprised of information relating primarily to three (3) entities: (i) the consumer (ii) the merchant, and (iii) the promotion. Each entity in turn contains temporal, spatial and meta-data attributes further defining elements of the profile. For a consumer, there is a stream of multi-dimensional data including latitude, longitude and altitude (spatial), a corresponding timestamp (temporal), and via the profile service 148, associated consumer meta-data including consumer profile information. For a merchant, the spatial information is primarily the fixed location of their venue, but may also represent a customer location associated with a special event. From a temporal perspective, a merchant may correlate a business goal to a time of day, day of week, or month in year (seasonal), and via the profile service 148, associated merchant meta-data including merchant profile information. For a promotion, the spatial elements match those of the merchant. The temporal elements represent the intended time of day, day of week and month of year matching the merchant's goals for increased consumer volume.

A tags profile 232 in the context of the Variable Value Promotion represent both standard and non-standard (i.e. custom) keywords used to identify or enhance meta data around consumers, merchants, promotions, venues and any entity participating in the promotion, sale and redemption of goods and services in the marketplace. Tags are used in the value calculation of a Variable Value Promotion with variable pricing based on the matching characteristics.

A tags profile 232 in the context of the Variable Value Promotion represent both standard and non-standard (i.e. custom) keywords used to identify or enhance meta data around consumers, purchasers, merchants, venues and any entity participating in the promotion, sale and redemption of goods and services in the marketplace. Tags are used in the value calculation of a Variable Value Promotion with variable pricing based on the matching characteristics.

A temporal context module 234 captures and formats one or more of the following pieces of information pertaining to the particular promotion:

1. Date Time: Time of Day (e.g. Happy Hour, Early Bird Special, Increased value when demand is low and decreased value when demand is high—demand based pricing)

2. Day of Week (e.g. Demand based value—restaurants are slow on Monday thru Wednesday and busier Thursday thru Saturday)

3. Month of Year (e.g. Seasonal variation in value)

4. Business Cycle: a discrete value representing level of business activity. This may be construed as seasonal, day of week, time of day or any other value ranking system. Theme being increased value when demand is low (e.g. High/Peak, Medium/Normal, Low/Off Season)

5. Any web traceable customer or business action in the System or 3rd party social network that creates additional and measurable activity surrounding a Promotion.

6. Any System activity or contextual information for a customer or business user, not included in the System Score, that provides additional context surrounding a Promotion that could be used to affect the Promotion value. (e.g. user statistics, demographics, psychographics, etc.)

A statistical trends module 236 captures and formats one or more of the following pieces of information pertaining to the particular promotion following information: (i) Consumer trends relative to temporal and location patterns, commerce and transaction patterns (ii) Merchant trends relative to venue reputation, level of activity over time (temporal), or statistical trends of meta-data. (e.g. commerce patterns surrounding special events). And finally (iii) Promotion trends relative to temporal patterns, location patterns, merchant category patterns, and promotion type patterns, and patterns of any defined promotion attribute, and any combination thereof.

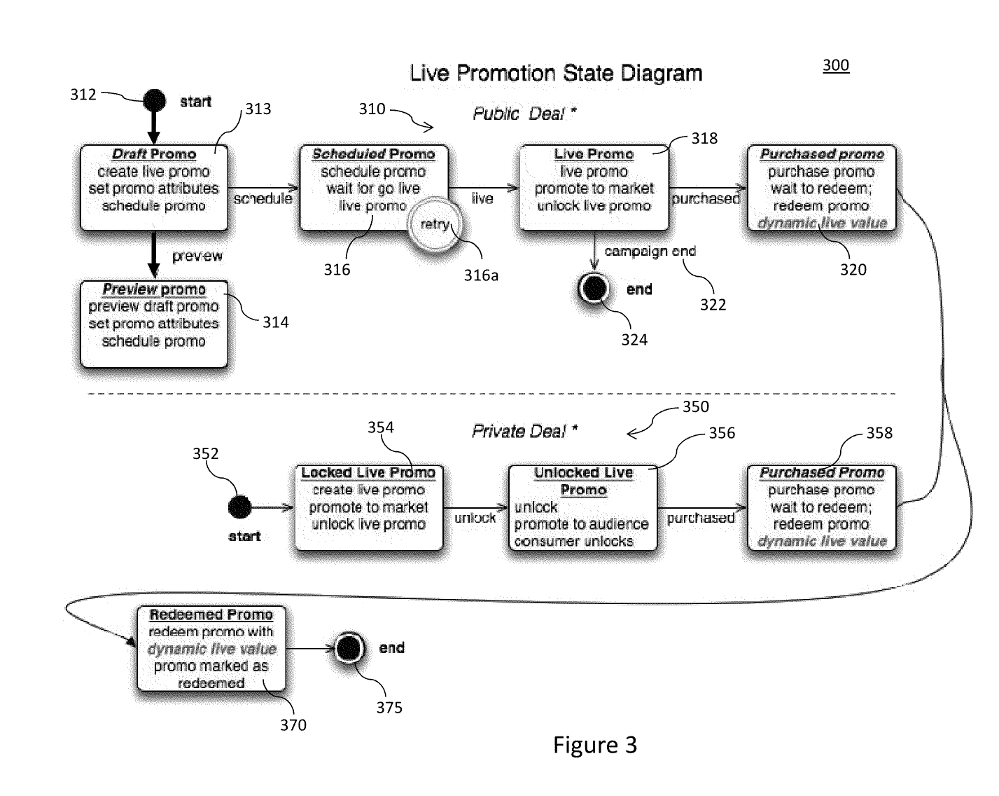

With reference now to FIG. 3, a Live Promotion State Diagram 300 is shown that illustrates on a broader and abstract level the behavior of the promotional system. State diagram 300 includes a public deal section 310 and a private deal section 350 and begins at node 312 and initiates a draft promotion state 313 where a live promotion is created, promotional attribute values are set and the promotion is scheduled. An option to preview the promotion is executed at state 314 and an option to formally schedule the promotion is executed at state 316. If an attempt is not successful or gives an error (e.g. a web error), the system retries at 316a until successful. A option to make the promotion live is executed at state 318 where the promotion is promoted to the market. At this point the promotion may either end at state 324 or it is purchased by a user at state 320. At state 320 aspects of the dynamic live value and the variable value promotion from FIG. 2 are incorporated into the promotion.

The purchased promotion executed at state 320 may then be passed to the private deal section 350 which has its own state execution beginning a 352, executing a “locked” live promotion at 354, unlocking the live promotion at 356 and allowing for the purchase of the promotion at 358. As with state 320 in the public deal section, state 358 in the private deal section allows for aspects of the variable value promotion from FIG. 2 to be incorporated into the promotion. From either the public deal 310 or the private deal 320 the promotion may be redeemed at 370 and the state diagram ends at 375.

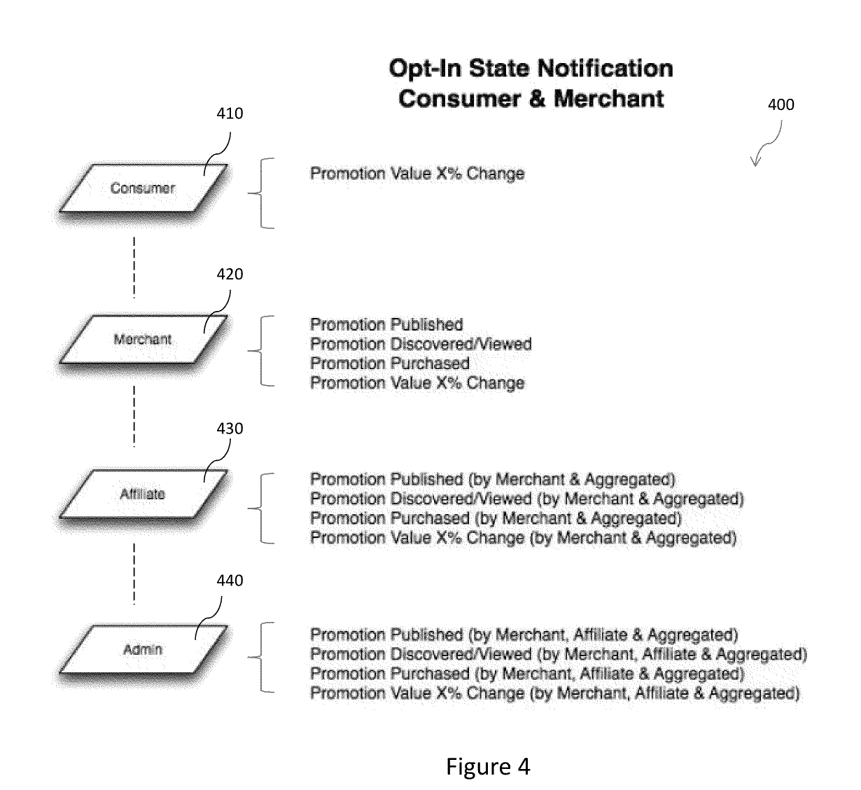

With reference to FIG. 4, various state interaction levels of a promotional system 400 described herein is shown. FIG. 4 illustrates the various privileges and interaction abilities that the several functions have within the system. For example, consumer 410 may see only the percentage change in the promotion value as a part of his or her interaction with the system 400. Merchant 420 however has the ability to see that the promotion has been published, that the promotion was discovered and/or viewed, that the promotion was purchased as well as the percentage change in the promotion value.

Affiliate 430 has the same viewing privileges as merchant 420 except that he also has the ability to view this data for an individual merchant as well as aggregated for all merchants the affiliate may be monitoring. Admin 440 has the same privilege levels as affiliate 430 expect that he additionally has the ability to see individual affiliate as well as any of the affiliates and merchants in an aggregated view.

### Customer Ranking and Value Attribute Calculations

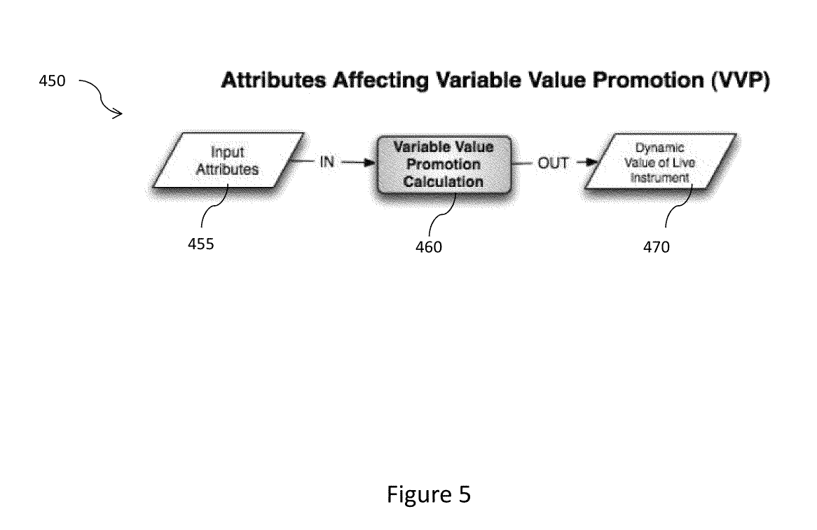

As mentioned above, aspects of a promotional system constructed in accordance with the present invention include the ability to assign a variable value to a particular promotion based on among other aspects, a customer ranking value. FIG. 5 describes in high level the variable value promotion attribute process 450 that includes providing inputs 455 into a variable value promotion calculation engine 460 and then calculating a dynamic value of the live promotional instrument at 470. A portion of this dynamic value is based both on the weighting of the value attributes discussed above in connection with FIG. 2 and step 212 and also on the value of a particular customer ranking. Aspects of this customer ranking are discussed below.

A promotional system constructed in accordance with aspects of the present invention collects, aggregates and analyzes multiple dimensions of data to allow merchants to score or otherwise rank their customers. These scores may then be used by the promotional system to improve promotion targeting based on both a customer ranking model, which includes standard and custom attribution and weighting as well as more static promotional criteria discussed above. These customer ranking attributes include one or more of the following:

### Spend

Spend refers to how much has the consumer spent with the merchant over a defined period of time. For example, do they buy high margin or low margin items? Is their spending frequency increasing, decreasing or flat over a defined period of time? Has consumer ever purchased a deal from the particular merchant? If yes, how many deals have they purchased over a defined period of time? Has consumer ever redeemed a deal from the merchant? If yes, did they spend more than the value of the deal? If yes, how much over? If yes, when did they come in? Is this a high demand or low demand time?

### Time Profile

Time profile refers to the temporal nature of when the consumer engages with the promotional system. For example, whether the consumer generally engages with promotional actions when demand is low/supply high or demand high/supply low? Does the consumer engage in the AM or PM? Does the consumer generally Engage in M-Th or F-Sun? Does the consumer generally come more in the spring, summer, fall or winter. Or, is there no correlation as to the consumer's temporal interaction?

### Frequency

Frequency refers generally to how often the consumer visits a particular merchant store. For example, does he visit infrequently, frequently, never?

### Customer Influence

Customer influence generally refers to whether and to what extent the particular consumer has shared deals with friends or other people and organizations in his network. For example, if he does share promotional deals, how many were shared? Of those shared, how many were purchased? How many followers/friends does the consumer have? (e.g. none, below average, average, above average, off the charts). What is their social score according to 3rd party metrics.

Merchant Influence over Customer

Merchant Influence over Customer generally refers to whether and to what extent a particular merchant has sent a targeted promotion to a particular consumer before. For example, did the consumer act on the targeted promotion?

### Connection to Business

Connection to Business generally refers to whether the consumer likes or otherwise follows the business. For example, does the consumer currently own an un-redeemed deal? Is it a ‘variable value promotion’? If yes, what are the current value attributes of the variable value promotion? What is the current discount? What is the min/max discount?

### Location

Location generally refers to where the consumer is relative to the merchant location. (e.g. in the store, within walking distance, driving within 15, etc.). For example, in one sense the most adaptable consumer might be the one who is the closest geographically since they presumably have the lowest “cost to act.”

### Tagging and Curating

Tagging and curating allows the merchant to add additional attributes and to weight these attributes in the overall algorithm for ‘best customer’. In this aspect, some level of human interaction to refine the attributes is available such as the attribution of social network attributes (like, tag, share, etc.). Human sensitivities allow for reweighting or the ability to otherwise manually override or bump up existing tags, add new tags, etc. This feature allows the application of specialized knowledge, insider information, or other personalized information to the variable value calculation.

### Algorithm

The algorithm for calculating Customer Ranking uses the above attributes as weighted inputs to compute a real-time customer ranking. Since some of these attributes are real-time (e.g. location of customer relative to merchant), the ranking may apply to alive promotion opportunity or more generally a customer ranking separate from a specific opportunity.

Accessing some of this information requires opt-in by the Consumer (e.g. location), aggregation and sharing of their customer ranking across other merchants, etc. The customer ranking algorithm is capable of producing a score with or without some of this information.

Based on a customer ranking, the Closely Service may target promotions with specific discounts to customers with a ranking above a defined threshold. If the Customer

### Additional Applications

Once a consumer has been ranked by more than a single merchant, this information may be aggregated providing a collective measure of “best customer”; highest scoring consumers receive the best incentives.

FIG. 6 shows a diagrammatic representation of one embodiment of a machine in the exemplary form of a computer system 500 within which a set of instructions for causing the device to perform any one or more of the aspects and/or methodologies of the present disclosure may be executed. Computer system 500 includes a processor 505 and a memory 510 that communicate with each other, and with other components, via a bus 515. Bus 515 may include any of several types of bus structures including, but not limited to, a memory bus, a memory controller, a peripheral bus, a local bus, and any combinations thereof, using any of a variety of bus architectures.

Memory 510 may include various components (e.g., machine readable media) including, but not limited to, a random access memory component (e.g., a static RAM “SRAM”, a dynamic RAM “DRAM, etc.), a read only component, and any combinations thereof In one example, a basic input/output system 520 (BIOS), including basic routines that help to transfer information between elements within computer system 500, such as during start-up, may be stored in memory 510. Memory 510 may also include (e.g., stored on one or more machine-readable media) instructions (e.g., software) 525 embodying any one or more of the aspects and/or methodologies of the present disclosure. In another example, memory 510 may further include any number of program modules including, but not limited to, an operating system, one or more application programs, other program modules, program data, and any combinations thereof.

Computer system 500 may also include a storage device 530. Examples of a storage device (e.g., storage device 530) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, and any combinations thereof. Storage device 530 may be connected to bus 515 by an appropriate interface (not shown). Example interfaces include, but are not limited to, SCSI, advanced technology attachment (ATA), serial ATA, universal serial bus (USB), IEEE 1394 (FIREWIRE), and any combinations thereof In one example, storage device 530 may be removably interfaced with computer system 500 (e.g., via an external port connector (not shown)). Particularly, storage device 530 and an associated machine-readable medium 535 may provide nonvolatile and/or volatile storage of machine-readable instructions, data structures, program modules, and/or other data for computer system 500. In one example, software 525 may reside, completely or partially, within machine-readable medium 535. In another example, software 525 may reside, completely or partially, within processor 505. Computer system 500 may also include an input device 540. In one example, a user of computer system 500 may enter commands and/or other information into computer system 500 via input device 540. Examples of an input device 540 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof Input device 540 may be interfaced to bus 515 via any of a variety of interfaces (not shown) including, but not limited to, a serial interface, a parallel interface, a game port, a USB interface, a FIREWIRE interface, a direct interface to bus 515, and any combinations thereof.

A user may also input commands and/or other information to computer system 500 via storage device 530 (e.g., a removable disk drive, a flash drive, etc.) and/or a network interface device 545. A network interface device, such as network interface device 545 may be utilized for connecting computer system 500 to one or more of a variety of networks, such as network 550, and one or more remote devices 555 connected thereto. Examples of a network interface device include, but are not limited to, a network interface card, a modem, and any combination thereof Examples of a network or network segment include, but are not limited to, a wide area network (e.g., the Internet, an enterprise network), a local area network (e.g., a network associated with an office, a building, a campus or other relatively small geographic space), a telephone network, a direct connection between two computing devices, and any combinations thereof A network, such as network 550, may employ a wired and/or a wireless mode of communication. In general, any network topology may be used. Information (e.g., data, software 525, etc.) may be communicated to and/or from computer system 500 via network interface device 545.

Computer system 500 may further include a video display adapter 560 for communicating a displayable image to a display device, such as display device 565. A display device may be utilized to display any number and/or variety of indicators related to pollution impact and/or pollution offset attributable to a consumer, as discussed above. Examples of a display device include, but are not limited to, a liquid crystal display (LCD), a cathode ray tube (CRT), a plasma display, and any combinations thereof In addition to a display device, a computer system 500 may include one or more other peripheral output devices including, but not limited to, an audio speaker, a printer, and any combinations thereof. Such peripheral output devices may be connected to bus 515 via a peripheral interface 570. Examples of a peripheral interface include, but are not limited to, a serial port, a USB connection, a FIREWIRE connection, a parallel connection, and any combinations thereof. In one example an audio device may provide audio related to data of computer system 500 (e.g., data representing an indicator related to pollution impact and/or pollution offset attributable to a consumer).

A digitizer (not shown) and an accompanying stylus, if needed, may be included in order to digitally capture freehand input. A pen digitizer may be separately configured or coextensive with a display area of display device 565. Accordingly, a digitizer may be integrated with display device 565, or may exist as a separate device overlaying or otherwise appended to display device 565.

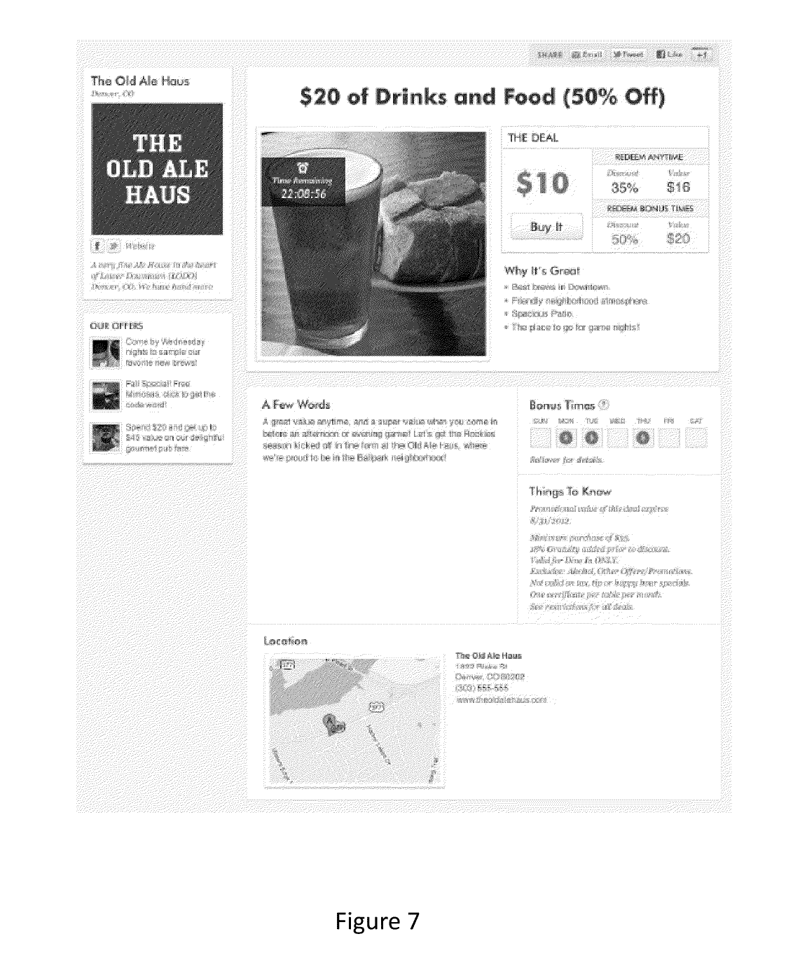

FIGS. 7-9 show several user interfaces that may be used on the consumer and merchant sides of the promotion system described herein. For example, FIG. 7 illustrates one example of a promotion offer as it might get presented to a consumer. Information relating to the promotion specifics are relayed as well as various pricing models that have been selected or tailored by the merchant. For example, the use of “bonus times” may be employed during non-peak hours or days where the promotion can be offered at an even greater or otherwise different discount.

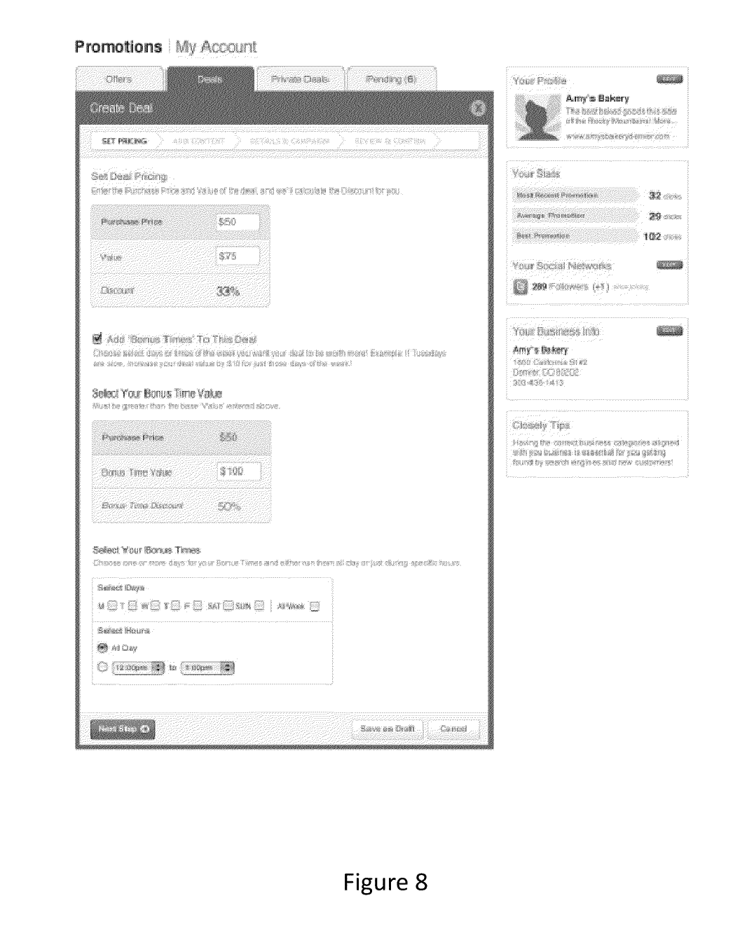

FIG. 8 illustrates one example of a merchant side user interface, showing the dashboard available to the merchant for him to control a variety of different offers that he is managing, the specifics of any particular deal, private deal characteristics and a monitoring window to keep track of the pending deals. Statistics are available for the merchant to monitor the promotions that are active or otherwise assigned to his account in the system.

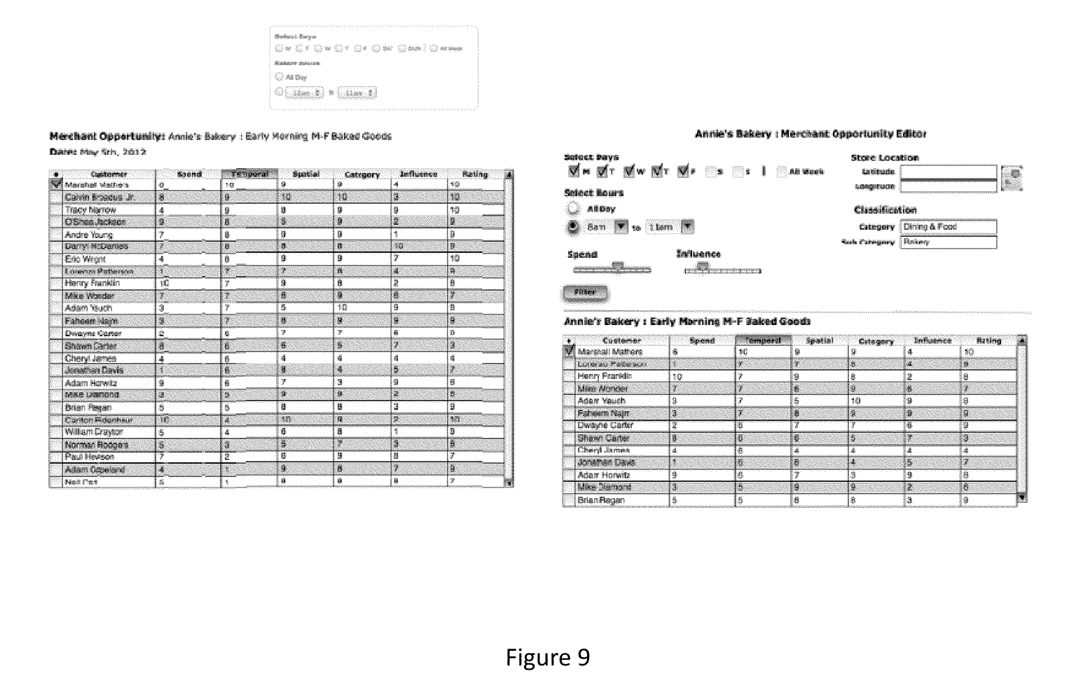

FIG. 9 illustrates some of the metrics used to quantify and otherwise characterize a particular users propensity for certain deals and to aid the merchant and system in determining the value that a particular deal should be assigned for a particular user. Various user profiles (spend, temporal, spatial, category, influence, and rating) are available for the merchant to review about any particular user or customer that is active in the promotional system.

Those skilled in the art can readily recognize that numerous variations and substitutions may be made in the invention, its use, and its configuration to achieve substantially the same results as achieved by the embodiments described herein. Accordingly, there is no intention to limit the invention to the disclosed exemplary forms. Many variations, modifications, and alternative constructions fall within the scope and spirit of the disclosed invention.

What is claimed is:

1. A system for advertising and promotion wherein the value of the promotion is determined based on a profile of the consumer, the system comprising:
a merchant server computer;
a microprocessor; and
a memory, the memory programmed to execute a method of calculating a value for and delivering a promotion to a consumer, the method comprising,
identifying a promotion to be offered to a consumer;
identifying a consumer that is interested in the promotion;
identifying a plurality of consumer-specific attributes;
using at least one of the consumer-specific attributes to determine a promotion offering value;
offering the promotion to the consumer at the promotion offering value;
wherein the plurality of consumer-specific attributes related to the promotion are selected from the group consisting of,
consumer purchasing data;
a consumer temporal profile; and
a consumer statistical trend profile;
determining whether the consumer agrees to purchase the promotion at the promotional offering value; and
determining whether to adjust the promotional offering value based on whether the consumer agreed to purchase the promotion.

2. The system for advertising and promotion of claim 1, wherein determining the offering value for the promotion is executed on the merchant server.

3. The system for advertising and promotion of claim 1, wherein determining the offering value for the promotion is executed on a server remote from the merchant server.

4. The system for advertising and promotion of claim 1, wherein the memory is located on the merchant server.

5. The system for advertising and promotion of claim 1, wherein the memory is located on a web application server remote from the merchant server.

6. The system for advertising and promotion of claim 1, further comprising an merchant interface and a consumer interface.

7. The system for advertising and promotion of claim 1, wherein the system is distributed across a wide area network.

8. The system for advertising and promotion of claim 1, wherein the system is distributed across a local area network.

9. The system for advertising and promotion of claim 1, further comprising a social network interface for gathering social network data about the consumer.

10. The system for advertising and promotion of claim 9, wherein the social network interface includes a database that contains the consumer social network data.

11. The system for advertising and promotion of claim 6, wherein the merchant interface includes a live offer management interface, a live offer notify/select interface, a live offer social rewards interface, and a user profile interface.

12. The system for advertising and promotion of claim 6, wherein the consumer interface includes a live offer notify/select interface, a live offer unlock/redeem interface, a live offer share interface, and a live offer social message interface.

13. A method of advertising and promotion, wherein the promotion value is varied according to the specific consumer being offered the promotion, the method comprising:
executing on a merchant computer server that includes a processor and memory, an algorithm adapted to,
identify a promotion to be offered to a consumer;
identify a consumer that is interested in the promotion;
identify a consumer-specific attribute related to the promotion;
use the consumer-specific attribute to determine a value for the promotion;
offer the promotion to the consumer at the determined promotion value;
determine whether the consumer agrees to purchase the promotion at the determined promotional value; and
determine whether to adjust the determined promotional value based on whether the consumer agreed to purchase the promotion.

14. The method of claim 13, wherein the consumer-specific attribute is a consumer purchaser profile.

15. The method of claim 13, wherein the consumer-specific attribute is a consumer temporal profile.

16. The method of claim 13, wherein the consumer-specific attribute is a consumer statistical trend profile.

17. The method of claim 13, wherein the consumer-specific attribute is a merchant opportunity profile.

18. The method of claim 13, wherein the algorithm further comprises further modifying the promotion value if the consumer declines the promotion offer.

19. The method of claim 13, wherein the algorithm further comprises determining whether to offer the promotion in a private or public market.

20. The method of claim 13, wherein the algorithm uses a plurality of consumer-specific attributes to determine a value for the promotion.
